(19) United States
(12) Patent Application Publication
(10) Pub. No.: US 2026/0153149 A1
(43) Pub. Date: Jun. 4, 2026

(54) INTAKE THROTTLE VALVE

(71) Applicant: AISAN KOGYO KABUSHIKI KAISHA, Obu-shi (JP)

(72) Inventors: Toshihide KOKUBU, Obu-shi (JP); Eisuke BABA, Kasugai-shi (JP); Shinsuke MATSUYAMA, Nagoya-shi (JP)

(73) Assignee: AISAN KOGYO KABUSHIKI KAISHA, Obu-shi (JP)

(21) Appl. No.: 19/378,726

(22) Filed: Nov. 4, 2025

(30) Foreign Application Priority Data
Dec. 2, 2024 (JP) 2024-209346

(51) Int. Cl. F16K 1/22; F02D 9/10

(52) U.S. Cl. CPC F16K 1/225; F02D 9/1005; F02D 9/1065; F16K 1/221

(57) ABSTRACT

An intake throttle valve includes a throttle body defining a fluid passage, a throttle valve disposed in the fluid passage, a throttle shaft secured to the throttle valve and having a first restricting surface, a needle bearing rotatably supporting the throttle shaft, a throttle gear coupled to the throttle shaft, and a mounting member fixed to the throttle gear and having a second restricting surface. The first restricting surface and the second restricting surface face each other across the needle bearing such that a gap exists in at least one of between the first restricting surface and the needle bearing, or between the second restricting surface and the needle bearing. The axial movement of the throttle shaft is prevented by the needle bearing when the needle bearing contacts either the first restricting surface or the second restricting surface.

### CROSS-REFERENCE TO RELATED APPLICATIONS

This application claims priority to Japanese patent application serial number 2024-209346 filed December 2, 2024, which is hereby incorporated herein by reference in its entirety for all purposes.

### BACKGROUND

The present disclosure relates generally to intake throttle valves.

Vehicles equipped with engines, such as automobiles, motorcycles, mopeds, and ships, typically include an intake throttle valve to control the amount of air entering the engine. The intake throttle valve usually includes a throttle body defining an intake passage, a throttle valve disposed in the intake passage, a throttle shaft rotatably supported by bearings and configured to be rotated by an electric motor, a disc-shaped throttle valve fixed to the throttle shaft, and a gear train that includes a throttle gear fixed to the throttle shaft. When the rotation of the electric motor is transmitted to the throttle shaft via the gear train, the throttle valve is rotated to open and close the intake passage to control airflow to the engine.

One existing intake throttle valve employs a lever securely fixed to the throttle shaft for controlling the opening and closing of the throttle valve while supporting the throttle shaft rotatably via the bearings. However, the intake throttle valve is not electrically operated and includes no throttle gear. Even if a throttle gear were attached to the lever of the intake throttle valve, the structure would be complex because restriction of the axial movement of the throttle shaft needs additional members, such as collars or cup members. Therefore, there is a need for an improved intake throttle valve that can restrict the axial movement of the throttle shaft and is designed for cost-effective production.

### SUMMARY OF THE INVENTION

The present disclosure relates to an intake throttle valve that includes a throttle body defining a fluid passage, a throttle valve that is disposed in the fluid passage to regulate fluid flow, a throttle shaft secured to the throttle valve, a needle bearing fixed to the throttle body and rotatably supporting the throttle shaft, a throttle gear coupled to the throttle shaft and driven by an electric actuator, and a mounting member fixed to the throttle gear. The throttle shaft has a first restricting surface. The mounting member has a second restricting surface. The first and second restricting surfaces face each other across the needle bearing such that a gap exists in at least one of between the first restricting surface and the needle bearing, or between the second restricting surface and the needle bearing. The axial movement of the throttle shaft is prevented by the needle bearing when the needle bearing contacts either the first restricting surface or the second restricting surface.

### BRIEF DESCRIPTION OF THE DRAWINGS

FIG. 1 is a cross-sectional view of an embodiment of an intake throttle valve.

FIG. 2 is an enlarged view of a part of the intake throttle valve, surrounded by a dashed line in FIG. 1.

### DETAILED DESCRIPTION

Some embodiments of the present disclosure are described below in reference to the drawings.

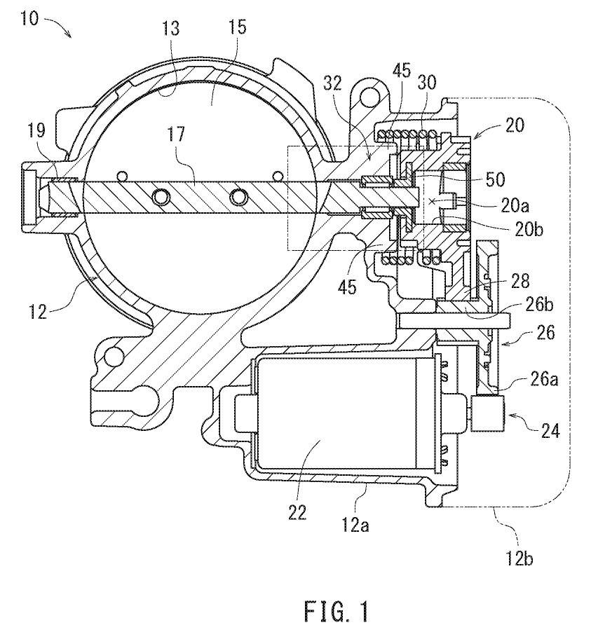

FIG. 1 shows an embodiment of an intake throttle valve 10 that is mounted on vehicles, such as automobiles and motorcycles, for controlling airflow to the engine. The intake throttle valve 10 includes a throttle body 12 defining a fluid passage 13 therethrough. The fluid passage 13 forms a part of the intake passage leading to the engine. The throttle body 12 may be made of metal or resin. The intake throttle valve 10 also includes a rotatable, disc-shaped throttle valve 15 that regulates the flow rate through the fluid passage 13. The throttle valve 15 is fixed to a throttle shaft 17 that is rotatably supported by the throttle body 12. The throttle valve 15 is inserted into a slit in the throttle shaft 17 and is fixed to the throttle shaft 17, e.g., by screws. The throttle shaft 17 is arranged along the diameter of the fluid passage 13 and is supported on both sides of the fluid passage 13 via bearings 19, 32 that are mounted on the throttle body 12. The throttle valve 15 can rotate between a fully closed position substantially perpendicular to the fluid passage 13 and a fully open position substantially parallel to the fluid passage 13. When rotating the throttle shaft 17, the throttle valve 15 is rotated to open and close the fluid passage 13. The throttle shaft 17 may be made of metal.

The intake throttle valve 10 includes a motor 22 that acts as an electric actuator for driving the throttle valve 15. The rotation output from the motor 22 is transmitted to the throttle shaft 17 via a transmission mechanism. The throttle body 12 includes a housing portion 12a with an open end, and a lid 12b closing the open end of the housing portion 12a. The motor 22 and the transmission mechanism are housed in the housing portion 12a. The transmission mechanism uses three main gears to transmit the motor’s output to the throttle shaft 17 including a driving gear 24 fixed to the output shaft of the motor 22, an intermediate gear 26 rotatably supported by the throttle body 12 via an intermediate shaft, and a throttle gear 20 that is a driven gear fixed coaxially to the throttle shaft 17. The intermediate gear 26 has a large-diameter tooth portion 26a and a small-diameter tooth portion 26b that are fixed coaxially on the intermediate shaft. The large-diameter tooth portion 26a meshes with the driving gear 24. The small-diameter tooth portion 26b meshes with a tooth portion 28 of the throttle gear 20. The throttle gear 20 may be made of resin. The throttle shaft 17 is fixed to the throttle gear 20 via a mounting member 50, also called a lever. The motor 22 is controlled by an external electronic control unit (ECU). The ECU controls the rotation direction and the amount of rotation of the motor 22 to regulate the opening of the throttle valve 15.

The intake throttle valve 10 includes a coil spring 30 that acts as a torsion spring to provide biasing force to push the throttle valve 15 back to its default position. The coil spring 30 is anchored at one end to the throttle body 12 and at the other end to the throttle gear 20, ensuring the biasing force is always applied to the throttle valve 15 via the throttle gear 20. When the motor 22 is powered (i.e., when the output shaft can be controlled), it overcomes the biasing force of the coil spring 30 to precisely control the throttle valve 15, rotating to any position between the fully closed position and the fully open position. When power to the motor 22 is lost, the coil spring 30 instantly takes over, applying the biasing force and rotating the throttle valve 15 back to its default position, allowing a minimal amount of air into the engine through the fluid passage 13.

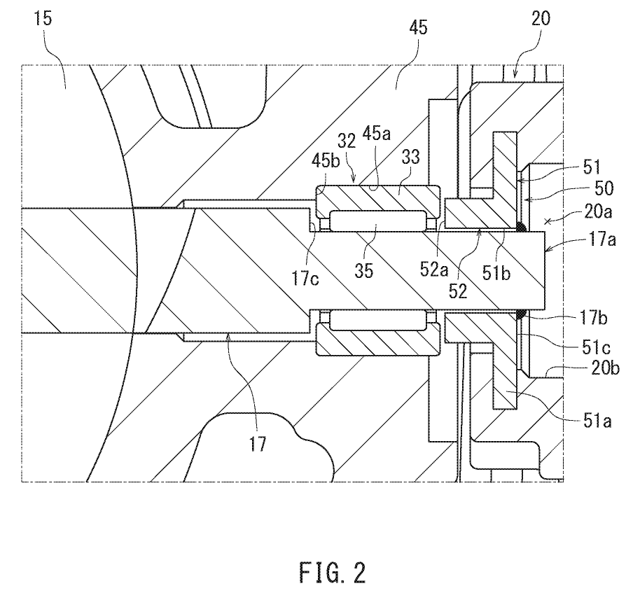

As shown in FIG. 2, the bearing 32 on the throttle gear 20 side is a needle bearing. The needle bearing 32 comprises an outer ring 33 and a plurality of needle rollers 35 that roll inside the outer ring 33. The throttle body 12 has a bearing retaining portion 45. The bearing retaining portion 45 has a cylindrical inner wall surface 45a, which retains the outer ring 33 of the needle bearing 32 by press fitting. The needle bearing 32 can be axially positioned by a bottom surface 45b of the bearing retaining portion 45. For example, the bearing retaining portion 45 can have a cylindrical body protruding from the throttle body 12 toward the throttle gear 20 (FIG. 1). One end of the coil spring 30 is positioned outside the cylindrical body of the bearing retaining portion 45. In another embodiment (not shown), a different kind of needle bearing may be used, which further includes an inner ring, with needle rollers rolling between the outer ring and the inner ring.

The throttle shaft 17 is secured to the throttle gear 20 via the substantially annular mounting member 50. The throttle gear 20 has a through portion 20a, or recess, that receives a tip 17a of the throttle shaft 17. The mounting member 50 may be made of metal. The mounting member 50 can be coupled to the throttle gear 20 by partially embedding the mounting member 50 into an inner wall surface 20b of the through portion 20a of the throttle gear 20, which is made of resin, by insert molding. The throttle gear 20 is connected to the throttle shaft 17 by welding the tip 17a of the throttle shaft 17 to the mounting member 50, e.g., by laser welding. FIG. 2 shows an exemplary welded portion 17b.

The throttle shaft 17 has a first restricting surface 17c. The mounting member 50 has a second restricting surface 52a. The first and second restricting surfaces 17c, 52a face each other across the needle bearing 32. The distance between the first restricting surface 17c of the throttle shaft 17 and the second restricting surface 52a of the mounting member 50 is set to prevent them from contacting the needle bearing 32 simultaneously. In other words, there is a gap is present in at least one of the following: between the first restricting surface 17c of the throttle shaft 17 and the needle bearing 32, or between the second restricting surface 52a of the mounting member 50 and the needle bearing 32. The axial movement (thrust movement) of the throttle shaft 17 is restricted by the needle bearing 32 contacting either the first restricting surface 17c of the throttle shaft 17 or the second restricting surface 52a of the mounting member 50. Eventually, the axial movement of the throttle shaft 17 can be prevented without specific additional components such as C-rings positioned around the throttle shaft 17, thereby reducing costs.

In one embodiment, the first restricting surface 17c of the throttle shaft 17 may be a stepped surface facing the needle bearing 32.

The mounting member 50 has a base portion 51 coupled to the throttle gear 20, and a cylindrical portion 52 extending from the base portion 51 toward the needle bearing 32. The base portion 51 may have a flat plate shape. An outer peripheral portion 51a of the base portion 51 is embedded into the throttle gear 20. In one embodiment, the mounting member 50 has a surface 51c of the base portion 51, which is on the side farthest from the needle bearing 32. The tip 17a of the throttle shaft 17 can be welded to an inner peripheral edge 51b of the surface 51c of the base portion 51. The welding may be performed continuously around the entire circumference of the inner peripheral edge 51b or discontinuously, e.g., in spots, at multiple locations along the inner peripheral edge 51b. In one embodiment, the second restricting surface 52a of the mounting member 50 may be the tip surface of the cylindrical portion 52 facing the needle bearing 32.

In one embodiment, the mounting member 50 may have an L-shaped cross-section. The inner peripheral edge 51b of the base portion 51 is circular, and the cylindrical portion 52 extends from the inner peripheral edge 51b of the base portion 51 toward the needle bearing 32. This configuration allows the mounting member 50 to have a simple tapered shape, facilitating forming. In another embodiment (not shown), the mounting member 50 may have a T-shaped cross-section. The cylindrical portion 52 extends from a portion located inward of the inner peripheral edge 51b of the base portion 51 toward the needle bearing 32. In yet another embodiment (not shown), the cylindrical portion 52 of the mounting member 50 may have a trapezoidal cross-section. That is, the diameter of the cylindrical portion 52 may increase from the tip surface (second restriction surface 52a) toward the base portion 51.

During assembly, the throttle shaft 17 is first inserted into the through hole of the throttle body 12. The needle bearing 32 is then inserted onto the tip 17a of the throttle shaft 17 while the outer ring 33 is press-fitted into the bearing retaining portion 45. The throttle gear 20, with the mounting member 50 embedded, is inserted onto the tip 17a of the throttle shaft 17. The tip 17a is welded to the mounting member 50. Finally, the throttle valve 15 is inserted into the slit of the throttle shaft 17 and secured to the throttle shaft 17 with screws.

The present disclosure is not limited to the above-described embodiments. A person skilled in the art can make various substitutions, improvements, and modifications without departing from the scope of the present disclosure.

The present disclosure includes various aspects as follows. In a first aspect, an intake throttle valve includes a throttle body forming a fluid passage, a throttle valve disposed in the fluid passage, a throttle shaft fixed to the throttle valve, a needle bearing fixed to the throttle body and rotatably supporting the throttle shaft, a throttle gear that is rotated by an electric actuator, and a mounting member fixed to the throttle gear. The throttle shaft and the mounting member include a first restricting surface and a second restricting surface, respectively, that face each other across the needle bearing such that a gap exists in at least one of between the first restricting surface of the throttle shaft and the needle bearing, or between the second restricting surface of the mounting member and the needle bearing. When the needle bearing contacts either the first restricting surface of the throttle shaft or the second restricting surface of the mounting member, the axial movement of the throttle shaft is prevented by the needle bearing.

In accordance with the first aspect of this disclosure, the axial movement of the throttle shaft can be restricted with a low-cost structure requiring fewer parts. This configuration suppresses wear between the throttle body and throttle valve, as well as malfunctions such as valve sticking.

What is claimed is:

1. An intake throttle valve, comprising:
a throttle body defining a fluid passage;
a throttle valve that is disposed in the fluid passage of the throttle body and configured to regulate fluid flow therethrough;
a throttle shaft fixably coupled to the throttle valve and having a first restricting surface;
a needle bearing fixably coupled to the throttle body and rotatably supporting the throttle shaft;
a throttle gear coupled to the throttle shaft and driven by an electric actuator; and
a mounting member fixably coupled to the throttle gear and having a second restricting surface,
wherein the first restricting surface and the second restricting surface face each other across the needle bearing such that a gap exists in at least one of (i) between the first restricting surface and the needle bearing, or (ii) between the second restricting surface and the needle bearing, and
wherein the needle bearing is configured to prevent the axial movement of the throttle shaft when the needle bearing contacts either the first restricting surface or the second restricting surface.
